(19) United States
(12) Patent Application Publication
(10) Pub. No.: US 2016/0167986 A1
(43) Pub. Date: Jun. 16, 2016

(54) SYSTEMS AND METHODS FOR REDUCING CORROSION IN A REACTOR SYSTEM USING ELECTROMAGENTIC FIELDS

(71) Applicant: EMPIRE TECHNOLOGY DEVELOPMENT LLC, Wilmington, DE (US)

(72) Inventors: Benjamin William MILLAR, Rosebery, New South Wales (AU); Benjamin Watson BARNES, Thornleigh, New South Wales (AU); George Charles PEPPOU, Hornsby Heights, New South Wales (AU)

(73) Assignee: EMPIRE TECHNOLOGY DEVELOPMENT LLC, Wilmington, DE (US)

(21) Appl. No.: 14/905,729

(22) PCT Filed: Jul. 16, 2013
(86) PCT No.: PCT/US13/50684

§ 371 Date: Jan. 15, 2016

(51) Int. Cl. C02F 1/48

(52) U.S. Cl. CPC C02F 1/485; C02F 2201/483; C02F 2303/08

(57) ABSTRACT

Systems and methods for reducing corrosion of components of a reactor system, such as a supercritical water gasification system are described. A current carrying element may be arranged about the outside surface of a system component, such as a valve, conduit, heater, pre-heater, reactor vessel, and/or heat exchanger. The current carrying element may be in the form of a continuous solenoid, rings, tubes, or rods, including a conductive material, such as copper. A current may be applied to the current carrying element to generate an electromagnetic field within the system component. The current may generate an electromagnetic field within the system component. The electromagnetic field may force corrosive ions moving within a fluid flowing through the system component to move in pathways away from an inner surface of the system component.

### BACKGROUND

Supercritical water gasification systems are capable of producing relatively clean hydrogen-based fuel from feedstocks that are typically considered waste, such as biowaste, or unclean fuel sources, including coal and other fossil fuels. During the supercritical water gasification process, water is heated to very high temperatures (for example, above about 674 Kelvin) under high pressure (for example, about 22 megapascals) that prevents the water from turning into steam. At this temperature, the water becomes very reactive and is capable of breaking down a feedstock slurry to generate the hydrogen-rich fuel. As the water is heated to these high temperatures, the water (“supercritical water”) can be very corrosive due to the precipitation of corrosive ions (for example, in the temperature range of about 570 Kelvin to about 647 Kelvin).

Conventional techniques to manage corrosion caused by supercritical water involve the constant replacement of corroded parts or constructing system components from corrosive resistant materials that are expensive and largely ineffective. Such techniques have ultimately proved too time consuming and cost-prohibitive because the corrosive ions still contact the surfaces of system components, which ultimately leads to surface breakdown. As such, there is not a method to reduce corrosion that operates to prevent the corrosive ions from contacting the component surfaces by affecting the flow of the corrosive ions through components of the supercritical water gasification system.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a reactor system configured to reduce corrosion thereof may comprise at least one current carrying element arranged in proximity to a surface of at least a portion of the reactor system. At least one pump may be configured to force fluid having corrosive ions disposed therein through the at least a portion of the reactor system. The system may comprise a current generator configured to pass a current through the at least one current carrying element to generate an electromagnetic field within the reactor system, wherein the electromagnetic field operates to reduce corrosion by forcing at least a portion of the corrosive ions away from an inner surface of the reactor system.

In an embodiment, a corrosion reduction method for a reactor system may comprise providing a reactor system having at least one current carrying element in proximity to a surface of at least a portion of the reactor system. A fluid having corrosive ions disposed therein may be moved through the at least a portion of the reactor system. A current may be passed through the at least one current carrying element to generate an electromagnetic field within the at least a portion of the reactor system, whereby the electromagnetic field forces at least a portion of the corrosive ions away from an inner surface of the reactor system.

In an embodiment, a method of manufacturing a reactor system configured to reduce corrosion thereof may comprise providing a reactor system having at least one current carrying element in proximity to a surface of at least a portion of the reactor system. At least one pump may be configured to force fluid having corrosive ions disposed therein through the at least a portion of the reactor system. The at least one current carrying element may be connected to a current generator configured to pass a current through the at least one current carrying element such that an electromagnetic field is generated within the reactor system that operates to reduce corrosion by forcing at least a portion of the corrosive ions away from an inner surface of the reactor system.

In an embodiment, a method of reducing corrosion in a coal gasification supercritical water reactor system may comprise arranging at least one current carrying element around at least a portion of a sub-critical zone of a reactor vessel of the supercritical water reactor system. A coal slurry having corrosive ions disposed therein may be moved through the reactor vessel from the sub-critical zone to a supercritical zone. A current may be passed through the at least one current carrying element to generate an electromagnetic field within the reactor vessel. The electromagnetic field may force at least a portion of the corrosive ions away from an inner surface of the reactor vessel.

### BRIEF DESCRIPTION OF THE DRAWINGS

FIG. 1 depicts an illustrative supercritical water system according to some embodiments.

FIG. 2A depicts a system component associated with a current carrying element according to a first embodiment.

FIG. 2B depicts a system component associated with a current carrying element according to a second embodiment.

FIG. 2C depicts a system component associated with a current carrying element according to a third embodiment.

FIG. 3 depicts a portion of an illustrative supercritical water gasification system configured according to an embodiment.

FIGS. 4A and 4B depict a detailed view of certain effects of a magnetic field within a system component according to some embodiments.

FIG. 5 depicts a top-down view of an illustrative magnetic field generated by a current carrying element according to some embodiments.

FIG. 6 depicts a cross-sectional view of an illustrative magnetic field generated by a current carrying element according to some embodiments.

FIG. 7 depicts a cross-sectional view of an illustrative magnetic field generated by a current carrying element having a diminishing diameter configured according to some embodiments.

FIG. 8 depicts a cross-sectional view of an illustrative magnetic field generated by a system component having a diminishing diameter configured according to an embodiment.

FIG. 9A depicts an illustrative current carrying element comprising electromagnets according to a first embodiment.

FIG. 9B depicts an illustrative current carrying element comprising electromagnets according to a second embodiment.

FIG. 10 depicts an illustrative current carrying element comprising electromagnets according to a third embodiment.

FIG. 11 depicts a flow diagram for an illustrative method of reducing corrosion in a supercritical water gasification system.

### DETAILED DESCRIPTION

The terminology used in the description is for the purpose of describing the particular versions or embodiments only, and is not intended to limit the scope.

The present disclosure relates generally to a system and methods for reducing corrosion in reactor systems, including in supercritical water reaction systems. In particular, embodiments provide for exerting electromagnetic influence on fluid flowing through reactor system components (“system components”), such as those in supercritical water reactor systems and supercritical water gasification systems, that may operate to force corrosive ions present in the fluid away from a surface of the system component. The electromagnetic influence on the fluid operates to implement magnetophoresis, which is the motion of dispersed magnetic and/or charged particles relative to a fluid under the influence of a magnetic field. According to some embodiments, a system component may be associated with a current carrying element configured to generate an electromagnetic field within the system component responsive to being energized by an electric current. The electromagnetic field may operate to influence the paths of ions within a fluid, such as supercritical fluid, passing through the system component. In an embodiment, Lorentz forces, as known to those having ordinary skill in the art, may be generated through the electromagnetic field to influence the path of the ions. In this manner, corrosion of system component surfaces may be reduced because corrosive ions within fluid present during operation of the reactor system may be prevented from reacting with the surface materials to cause corrosion. The reactors in some embodiments may be supercritical water reactors.

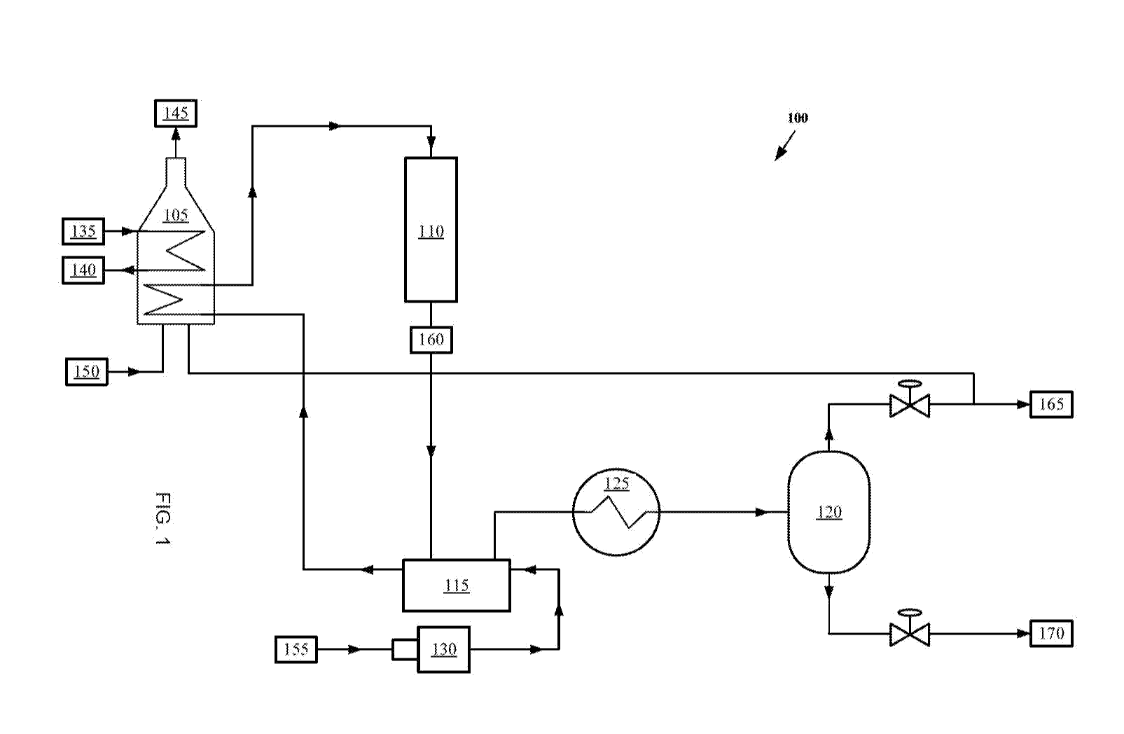

FIG. 1 depicts an illustrative supercritical water gasification system according to some embodiments. As shown in FIG. 1, a supercritical water gasification system 100 may comprise a feedstock inlet 130 for introducing a slurry 155 into the system. The slurry 155, for example, may include a high pressure slurry feed. The slurry 155 may comprise any type of matter capable of undergoing supercritical water gasification, including, without limitation, biomass fluids (for example, micro algae fluids, bioresidues, biowastes, or the like), slurries of coal and other fossil fuels, and oxidizable wastes. Accordingly, the supercritical water gasification system 100 may be configured to operate as various gasification systems, including, without limitation, a coal gasification system, a biomass gasification system, a waste oxidation system, a hydroprocessing reactor, and a pressurized water reactor. The slurry 155, along with air 150 and fluid 135, may be fed into a heater 105, such as a gas-fired heater. In an embodiment, the fluid 135 may comprise water. The combination of the slurry 155 and the fluid 135 may be heated in the heater 105. Certain gases, such as steam 140 and flue gas 145, may be exhausted from the heater 105, for instance, to maintain pressure within the heater 105. The combination of the slurry 155 and the fluid 135 may be fed into a reactor vessel 110.

Within the reactor vessel 110, the fluid 135 may be heated under pressure to become a supercritical fluid. The temperatures and pressures for generating a supercritical fluid may depend on the type of fluid and the composition thereof (for example, the type and concentration of ions at different temperatures and pressures). In an embodiment in which the fluid 135 comprises water, the fluid may be heated to at least about 647 Kelvin at a pressure of at least about 23 megapascals to become a supercritical fluid. During the supercritical water gasification process, the fluid 135 may be heated to various other temperatures to become supercritical fluid, including about 650 Kelvin, about 700 Kelvin, about 800 Kelvin, about 900 Kelvin, about 950 Kelvin, or ranges between any two of these values (including endpoints). The fluid 135 at supercritical temperatures may be at various pressures during the supercritical water gasification process, such as about 22 megapascals, about 23 megapascals, about 24 megapascals, about 25 megapascals, about 30 megapascals, or values between any two of these values (including endpoints).

The fluid 135 under supercritical conditions (“supercritical fluid”) includes corrosive ions such as the ions of various inorganic salts. The corrosive ions may be highly corrosive to the components of the supercritical water gasification system 100, such as the inside surface of system components, including the heater 105, the reactor vessel 110, and/or any pipes connecting the components together. In an embodiment, the corrosive ions may comprise anions and/or cations. Non-limiting examples of anions include chloride ions, fluoride ions, sulfide ions, sulfate ions, sulfite ions, phosphate ions, nitrate ions, carbonate ions, bicarbonate ions, hydroxide ions, oxide ions, and cyanide ions.

The supercritical fluid 135 may react with the slurry 155 within the reactor vessel 110 to generate a reactor product 160. In an embodiment, the fluid 135 may comprise one or more catalysts configured to facilitate the reaction, such as chlorine, sulfate, nitrate, and phosphate. The reactor product 160 may move through one or more heat exchangers, such as a heat recovery heat exchanger 115 and a cool-down heat exchanger 125. A gas/fluid separator 120 may be provided to separate the reactor product 160 into the desired fuel gas product 165 and waste products 170, such as fluid effluent, ash and char. The fuel gas product 165 may include any fuel capable of being generated from the slurry 155 responsive to reacting with the fluid 135 under supercritical conditions. Illustrative fuel gas products 165 include, but are not limited to, hydrogen-rich fuels, such as H₂ and/or CH₄.

During the supercritical water gasification process, the fluid 135 may be heated to various temperatures under different pressures within the supercritical water gasification system 100 outside of the supercritical temperatures described above. In addition to supercritical conditions, the fluid 135 may be in a subcritical condition, wherein the fluid 135 is at a high temperature, under pressure, that is below the supercritical temperature. In an embodiment wherein the fluid 135 comprises water, subcritical water may have a temperature of about 600 Kelvin, about 610 Kelvin, about 620 Kelvin, about 630 Kelvin, about 647 Kelvin, or in a range between any of these values (including endpoints). In an embodiment wherein the fluid 135 comprises water, the pressure of the fluid at the subcritical temperature may be about 20 megapascals, about 22 megapascals, about 25 megapascals, or in a range between any of these values (including endpoints). The subcritical fluid 135 may also comprise corrosive ions that are highly corrosive to the system components of the supercritical water gasification system 100.

The supercritical water reactor system 100 depicted in FIG. 1 is provided for illustrative purposes only and may comprise more or less components as required, such as one or more valves, pre-heaters, reactor vessels, pumps for pumping the fluid 135 through the system and other components known to those having ordinary skill in the art.

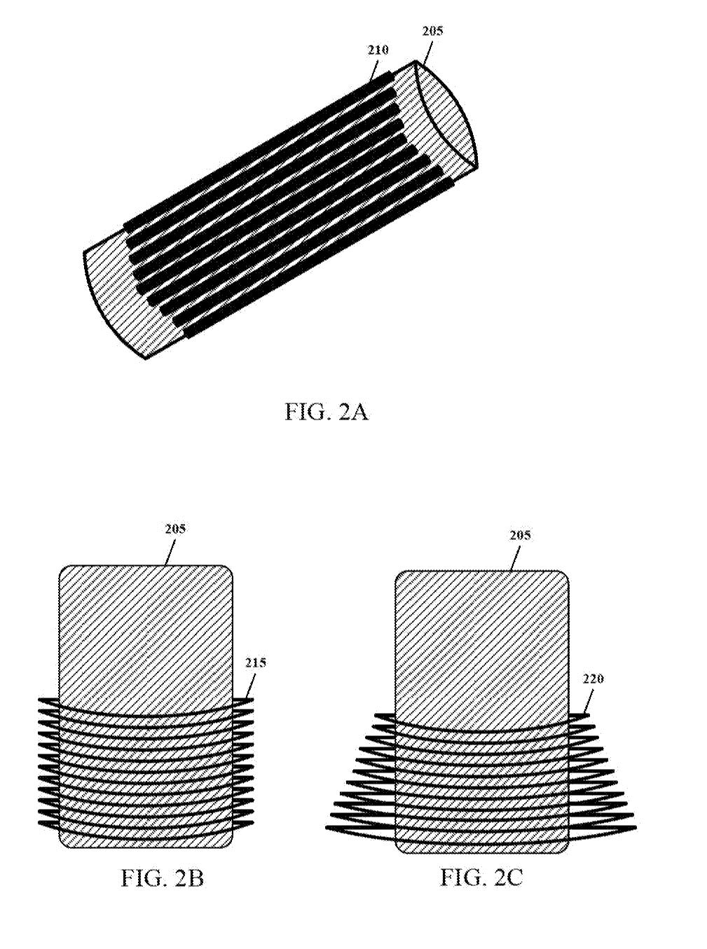

FIG. 2A depicts a system component associated with a current carrying element according to a first embodiment. As shown in FIG. 2A, a current carrying element 210 may be arranged around the outside surface of a system component 205. The system component 205 may comprise various system components configured to receive a fluid with corrosive ions disposed therein during the supercritical water gasification process. In this embodiment, the current carrying element 210 may be configured as rods and/or tubes comprising one or more wires. The current carrying element 210 may be configured to encircle a portion of the system component 205 with longitudinal direct current carrying wires. In an embodiment, the wires may have low resistance and high current capacity. In an embodiment, the wires may be independently insulated and each wire may carry current in the same direction.

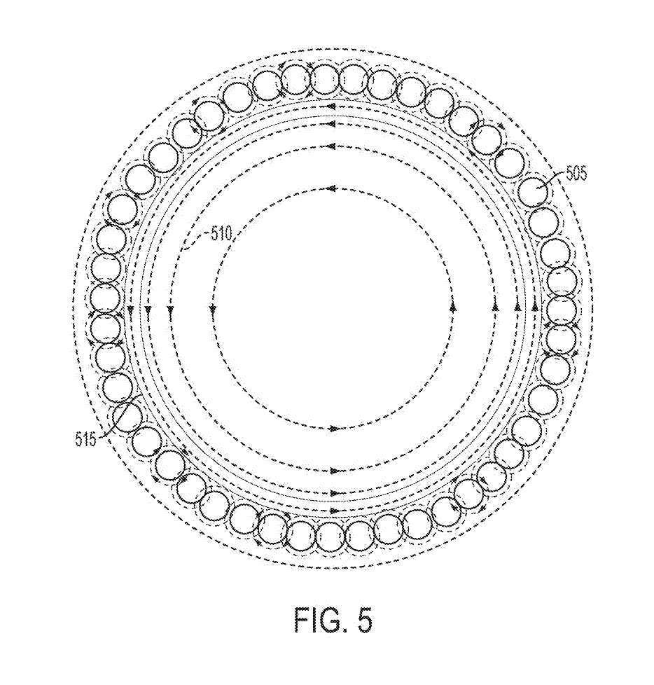

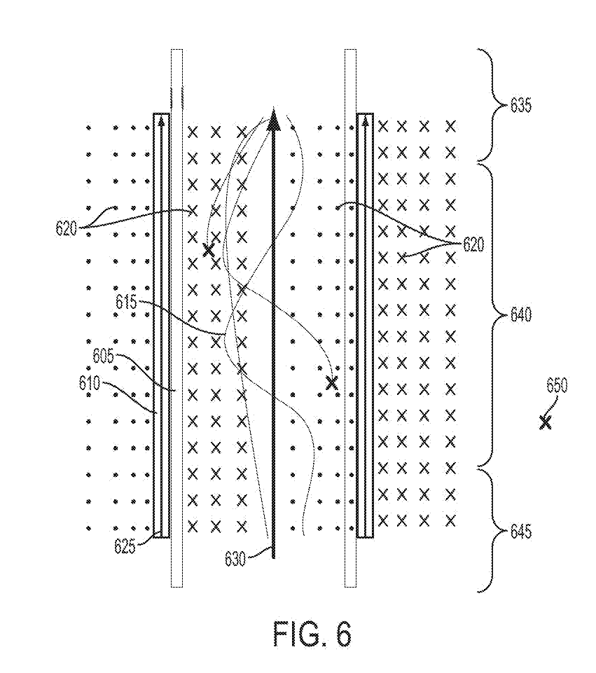

Energizing the current carrying element 210 may operate to generate an electromagnetic field within the system component 205. The combination of the fields of the encircling wires may produce a magnetic field, such as the magnetic field depicted in FIGS. 5 and 6. The strength of this combined field and its penetration into the system component 205 and any fluid flowing therein may depend on, among other things, the quantity of current flowing through each wire, the number of wires, and/or the diameter of the system component. The number of rods, tubes and/or wires required may depend on various properties of the system component 205, such as the circumference of the system component and the wire diameter required to provide sufficient current capacity through the system component. Embodiments provide that some or all of the current carrying element 210 may be insulated or un-insulated and may be located on or about an outside surface of the system component 205 or embedded within a wall of the system component.

In an embodiment, the rods, tubes and/or wires of the current carrying element 210 may be packed closely together to produce a uniform internal field. In this embodiment, a low voltage may be sufficient to allow conduction and maintain a manageable level of heat produced from resistance. In an embodiment, thick diameter copper rods and/or tubes may allow for increased current quantities, for example, up to the order of 10⁵ Amps; however, lower current levels may also be used to generate a magnetic field according to embodiments described herein.

The energized current carrying element 210 may generate heat. In an embodiment, some or all of the excess heat may be used to heat the fluid within the system component 205. In another embodiment, some or all of the current carrying element 210 may be cooled externally, for example, by directing heat to existing heat exchangers or by cooling due to the passage of a slurry through the system component 205. The lower the resistance of the coil, the less the resistive heat loss inefficiency and required coil cooling.

FIGS. 2B and 2C depict a system component associated with a current carrying element according to a second embodiment and third embodiment, respectively. As shown in FIGS. 2B and 2C, the system component 205 may have a current carrying element 215, 220 associated therewith. The current carrying element 215, 220 may comprise one or more concentric rings positioned about the outside surface of the system component 205. According to some embodiments, the current carrying element 215, 220 may comprise a single, unitary solenoid wherein each ring is connected to at least one other ring. According to other embodiments, the current carrying element 215 may comprise a plurality of separate rings. In the second embodiment depicted in FIG. 2B, each ring is the same or substantially the same size.

In the third embodiment depicted in FIG. 2C, the rings are differentially sized to produce a tapered current carrying element 220. In an embodiment, the tapered current carrying element 220 may be configured as a conical helix coil wound around the outside surface of the system component 205. In another embodiment, the tapered current carrying element 220 may be configured as a set of rings having different diameters. According to some embodiments, the coil of the tapered current carrying element 220 may be of a greater diameter at a fluid entrance of the system component 205 which steadily reduces to a smaller diameter at the end of the coil. In this manner, the coil of the tapered current carrying element 220 may be configured to surround a vulnerable region of the system component 205 and a small distance on either side of the vulnerable region. In an embodiment, the coil of the tapered current carrying element 220 may be constructed of an insulated high conductivity material the same or similar to the conducting wires in the second embodiment depicted in FIG. 2B.

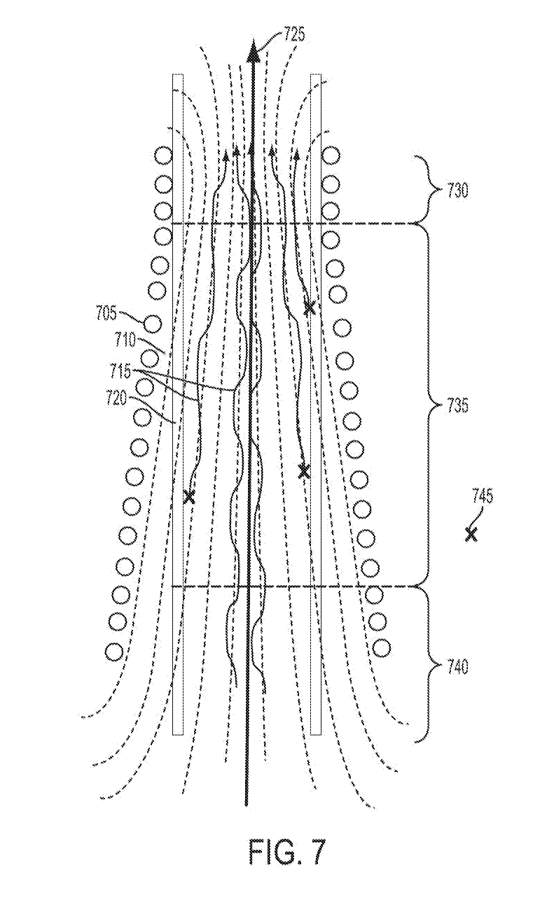

Energizing the current carrying elements 215, 215, 220 may operate to generate a magnetic field within the system component 205. FIG. 6, described below, depicts an illustrative electromagnetic field resulting from energizing the current carrying element and/or elements 210, 215 depicted in FIGS. 2A and 2B. FIG. 7, described below, depicts an illustrative electromagnetic field resulting from energizing a tapered current carrying element, such as the current carrying element 220 depicted in FIG. 2C.

Current carrying elements or systems 210, 215, 220 may be configured to generate magnetic fields of various strengths. The greater the current flow and coil density, the stronger the magnetic field. For instance, coil density must be high in order to produce a uniform magnetic field. In an embodiment, the coil density may include about 100 coils per meter. In addition, the quantity of power required to achieve a particular magnetic field may depend on various factors, including the scale, structure, and location of the system component 705 and/or current carrying elements or systems 210, 215, 220. According to some embodiments, the strength of a magnetic field may be about 10 microteslas, about 100 microteslas, 0.5 teslas, about 1 tesla, about 2 teslas, about 3 teslas, or a range between any two of these values (including endpoints). The current carrying elements 215, 215, 220 may be energized using various methods, including, without limitation, direct current, alternating current, and high-frequency alternating current. According to embodiments, the high-frequency alternating current may be about 100 kilohertz, about 200 kilohertz, about 300 kilohertz, about 400 kilohertz, about 500 kilohertz, or ranges between any two of these values (including endpoints).

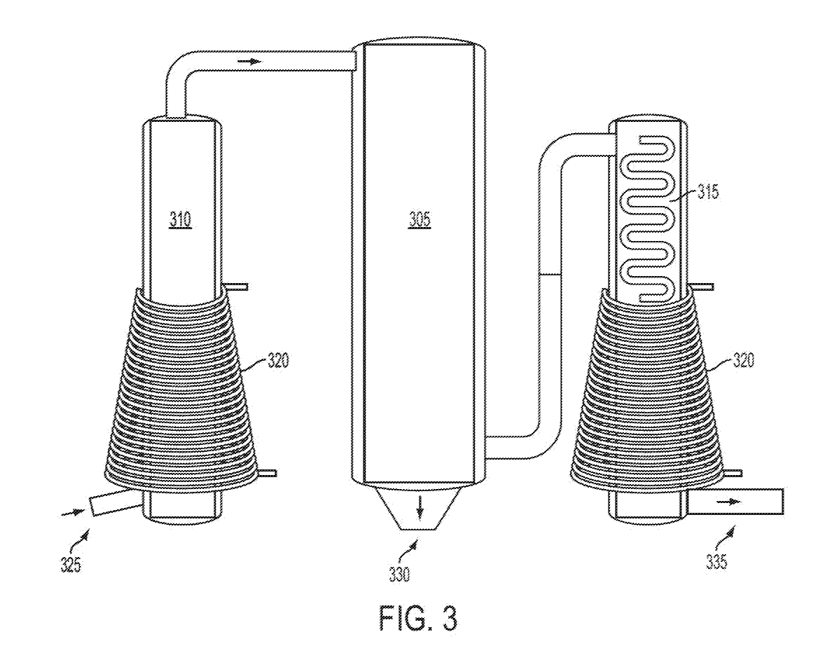

FIG. 3 depicts a portion of an illustrative supercritical water gasification system configured according to an embodiment. As shown in FIG. 3, a supercritical water gasification system may comprise a heater 310 in fluid communication with a reactor vessel 305, which is in fluid communication with a heat exchanger 315. Fluid 325 may be heated in the heater 310 before being fed into the reactor vessel 305. According to some embodiments, the fluid 325 may be in a subcritical state within the heater 310 and the heat exchanger 315, and may be in a supercritical state within at least a portion of the reactor vessel 305. Various by-products 330, such as slag, of the slurry-supercritical water reaction may be released from the reactor vessel 305. Pressurized synthesis gas 335 generated through the supercritical water gasification process may be released from the heat exchanger.

One or more of the components 305, 310, 315 may be associated with a current carrying element 320. The one or more of the components 305, 310, 315 may be fabricated from various materials, such as common corrosion resistant metals including, without limitation nickel alloy, chrome-molybdenum alloy, non-magnetic iron-based alloy, and/or certain ceramic materials. Such materials are generally not magnetizable, do not typically possess high magnetic permeability, and/or do not shield interior processes from a large magnetic field. As depicted in FIG. 3, a current carrying element 320 may be arranged about the outside surface of the heater 310 and the heat exchanger 315 (for example, the pre- and post-supercritical zones or subcritical zones of a supercritical water gasification system). The confinement of ions carried in solution by use of magnetic fields generated through energizing the current carrying elements 320 is a reliable method of preventing destructive ionic reactants from contacting an inner surface of a system component, such as the heater 310 and the heat exchanger 315.

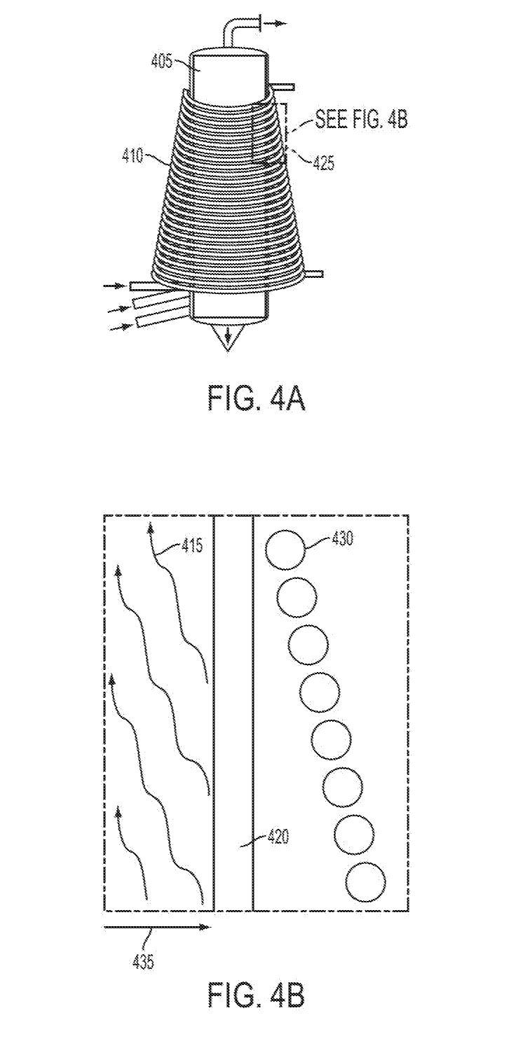

FIG. 4A depicts a detailed view of certain effects of a magnetic field within a system component according to some embodiments. As shown in FIG. 4A, a current carrying element 410 may be arranged around the outside surface of a system component 405. A detailed view 425 of FIG. 4A, depicted in FIG. 4B, illustrates the flow paths 415 of newly dissolved ions in a fluid flowing through the system component 405. As shown in FIG. 4B, The flow paths 415 flow away from the inner surface 420 of the system component 405 responsive to the Lorentz forces generated through the magnetic field produced by energizing the coils 430 of the current carrying element 410. Due to the direction of the flow paths 415 away from the inner surface 420, there is a decreasing ion concentration 435 from the center of the system component 405 to the inner surface 420.

Accordingly, the current carrying element 410 may operate to separate out magnetically susceptible particles from a bulk fluid (for example, a slurry). The magnetically susceptible particles may include anions, cations, ferromagnetic particles and/or non-ferromagnetic particles. According to some embodiments, anions may be the most corrosive of the magnetically susceptible particles and, as such, minimizing anion contact with component surfaces may have a greater impact on reducing corrosion as compared to the other magnetically susceptible particles. In some other embodiments, all of the magnetically susceptible particles may have substantially the same corrosive effect on component surfaces.

The magnetic field generated by energizing the current carrying element 410, such as the coils 430 depicted in FIG. 4B, may comprise various properties. For example, the properties of the magnetic field may be selected based on characteristics of system components and/or any fluids (for example, slurries, supercritical water, subcritical water, or the like). In an embodiment, an alternating electromagnetic field may be used to eliminate the reliance on externally driven direct and constant ion flow through a system component by inducing such motion. An alternating field may also produce dielectric and ion drag heating of the contents of a system component (for example, a heater or a furnace) and induce resistive heating in the casing thereof. In this manner, an alternating field may contribute to the heating of water, slurry and/or other fluids within a supercritical water gasification system.

FIG. 5 depicts a top-down view of an illustrative magnetic field generated by a current carrying element according to some embodiments. As shown in FIG. 5, a system component 515 may have a current carrying element 505 arranged about an outside surface thereof. For example, the current carrying element 505 may comprise a plurality of rods the same or similar to the plurality of elements for the current carrying element 210 depicted in FIG. 2. In an embodiment, the current carrying element 505 may comprise a plurality of direct current carrying wires. In the embodiment depicted in FIG. 5, the direction of current through the plurality of rods flows into the page, thereby generating a magnetic field 510 including multiple magnetic field lines. As fluid carrying corrosive ions flows through the magnetic field 510, the direction of flow of some or all of the corrosive ions may be influenced by the magnetic field, for instance, away from the inner surface of the system component 515.

FIG. 6 depicts a cross-sectional view of an illustrative magnetic field generated by a current carrying element according to some embodiments. As shown in FIG. 6, a system component 605 may have a current carrying element 610 arranged about an outside surface thereof. For example, the current carrying element 610 may comprise a plurality of rods the same or similar to the current carrying elements 210 depicted in FIG. 2A. The current carrying element 610 may be energized by a power source (not shown) which generates a magnetic field 620. In FIG. 6, the dots indicate that the magnetic field is directed out of the page and the ×s indicate that the magnetic field is directed into the page, in accordance with the current direction 625. The magnetic field 620 may operate to influence the paths 615 of ions within the fluid starting from an ion dissolution point 650.

In the embodiment depicted in FIG. 6, the system component 605 may comprise a reactor vessel where fluid flows through multiple zones 635, 640, 645 in a particular direction 630. The multiple zones may include, without limitation, a low corrosion zone 645, a high corrosion zone 640 and a supercritical zone 635. In the low corrosion zone 645, the fluid may be at a temperature less than 500 Kelvin and ion concentration may be low relative to the high corrosion zone 645 and the supercritical zone 635. In the high corrosion zone 640, the fluid (for example, a coal slurry) may be at a temperature at about 570 Kelvin to about 647 Kelvin. The ion concentration in the high corrosion zone 640 increases drastically, for example, at about 624 Kelvin. Above this temperature, ions may begin to precipitate and the ion product may be reduced, resulting in a more corrosive fluid within the high corrosion zone 640. In the supercritical zone 635, the fluid may be at a temperature above about 647 Kelvin and the corrosive ions may have been removed from the fluid.

As demonstrated in FIG. 6, magnetophoretic action of a uniformly cyclic magnetic field 620 on mobile solute anions travelling perpendicular to the field may operate to alter the path of the ions 615. For example, when current is flowing in a particular current direction 625, anions may be compelled into a net drift away from the inner surface of the system component 605. In an embodiment wherein the direction of the current was the reverse of the current direction 625, cations may experience the same effect. The magnetic field weakens with distance from the wires, and therefore distance from the inner surface. According to some embodiments, only prevention from contact and interaction with the inner surface is required. As such, the magnetic field gradient may allow for a high strength field to be present only where needed and may reduce incidences of ions spiraling against the inner surface.

FIG. 7 depicts a cross-sectional view of an illustrative magnetic field generated by a current carrying element having a diminishing diameter configured according to some embodiments. As shown in FIG. 7, a system component 720 may have a current carrying element 705 arranged about an outside surface thereof. For example, the current carrying element 705 may comprise a helical coil the same or similar to the tapered current carrying element 220 depicted in FIG. 2C. The current carrying element 705 may be energized by a power source (not shown) which generates a magnetic field 710. The magnetic field 710 may operate to influence the paths 715 of ions within the fluid starting from an ion dissolution point 745.

The system component 720 may comprise a reactor vessel where fluid flows through multiple zones 730, 735, 740 in a particular direction 725. According to some embodiments, the system component 720 may comprise a reactor vessel of a continuous supercritical water coal gasification system. The multiple zones may include, without limitation, a low corrosion zone 740, a high corrosion zone 735 and a supercritical zone 730, similar to zones 645, 640, 635 described above in relation to FIG. 6. As demonstrated in FIG. 7, the magnetic field 710 generated by the current carrying element 705 having a diminishing diameter may produce a convergence which maintains existing ions in a central location and causes central migration of newly dissolved 745 ions. Each “ring” of the current carrying element 705 may be comprised of hundreds or thousands of windings of a length of insulated wire, for example, in a manner similar to inductors known to those having ordinary skill in the art. Accordingly, the current carrying element 705 may be capable of producing a large magnetic field from a moderate current due to the large number of windings. According to some embodiments, current flowing around these rings uniformly in the same angular direction as in the coil may operate to generate an overall field having the same or substantially the same shape. In an embodiment, a performance gain may be achieved by using such rings under superconducting conditions.

Due to Lorentz forces acting on moving charged particles (for instance, the corrosive ions in the fluid) within the system component 720, a strong magnetic field 710 produced by the current carrying element 705 may operate to confine a charged particle to oscillating about field lines when the direction of particle flow and field are parallel, as depicted in FIG. 7. The magnetic field 710 depicted in FIG. 7 may operate to confine both anions and cations in solution.

The magnetic field across the internal diameter of a solenoid is approximately constant, and its flux density increases as diameter decreases. The tapered diameter of the solenoid or discrete rings of the current carrying element 705 may cause the direction of the magnetic field lines to move away from the inner surface of the system component 720 as the magnetic field diameter shrinks and the diameter of the system component 705 remains constant. Accordingly, existing and newly dissolved ions 745 are removed from contact with the inner surface in vulnerable zones by the resulting ion drift, minimizing exposure magnitude and duration. In an embodiment, a continuous direct current may be applied to produce a static magnetic field 710 having the shape depicted in FIG. 7. The influence of this magnetic field 710 over the charged particles 745 originates from the particles' motion through the system component 720 due to the flow of fluid. The resulting magnetophoresis may cause ion drift towards the center of the system component 720 and away from an inner surface thereof.

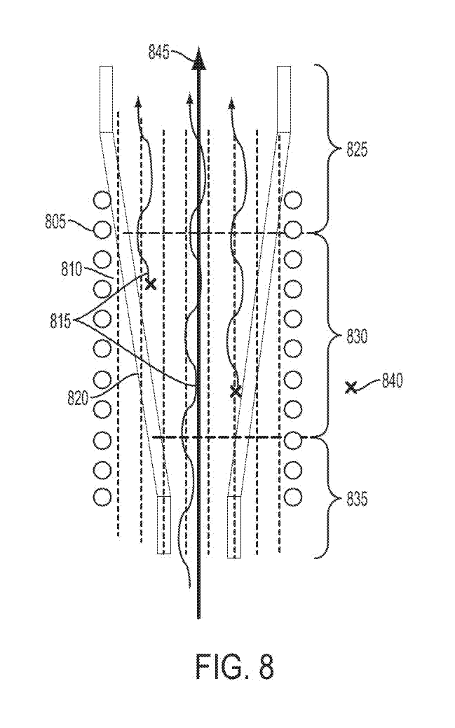

The ion drift depicted in FIG. 7 may be implemented using various alternative system configurations. For instance, FIG. 8 depicts a cross-sectional view of an illustrative magnetic field generated by a system component having a diminishing diameter according to an embodiment. As shown in FIG. 8, a system component 820 may have a current carrying element 805 arranged about an outside surface thereof. For example, the current carrying element 805 may comprise a helical coil the same or similar to the current carrying element 215 depicted in FIG. 2B. The current carrying element 705 may be energized by a power source (not shown) which generates a magnetic field 810. The magnetic field 810 may operate to influence the paths 815 of ions within the fluid starting from an ion dissolution point 845.

The system component 820 may comprise a reactor vessel where fluid flows through multiple zones 825, 830, 835 in a particular direction 845. The multiple zones may include, without limitation, a low corrosion zone 835, a high corrosion zone 830 and a supercritical zone 825, similar to zones 645, 640, 635 and zones 730, 735, 740 described above in relation to FIGS. 6 and 7, respectively. The system component 820 may be tapered, for example, having a smaller diameter in a low corrosion zone 835 and increasing in diameter through the high corrosion zone 830. The system component 820 may stop tapering at a point within the supercritical zone 825 and the diameter may remain constant for the remaining length of the system component.

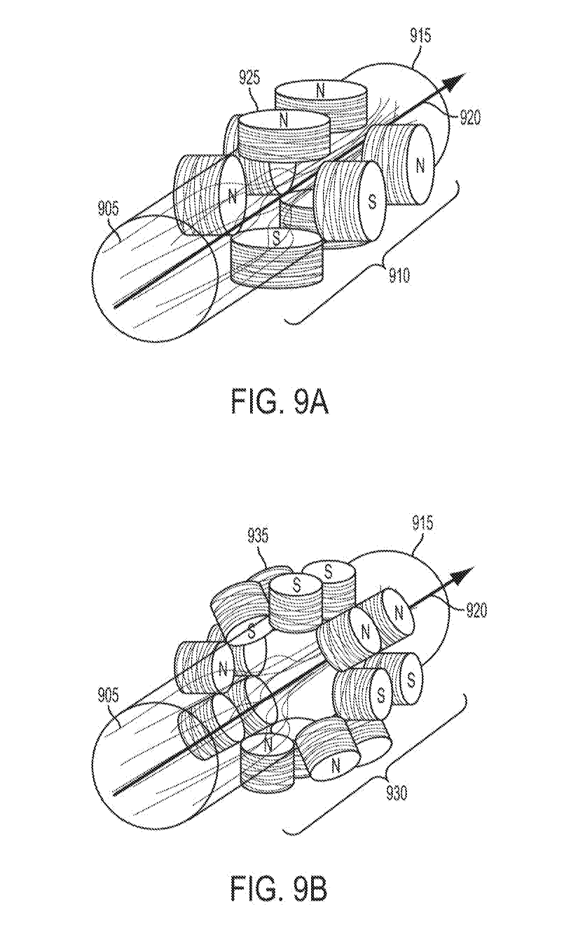

FIGS. 9A and 9B depict an illustrative current carrying element comprising electromagnets according to a first and second embodiment, respectively. As shown in FIG. 9A, a current carrying element 910 may be arranged around the outside surface of a system component 915, such as a reactor vessel or a heater. The current carrying element 910 may be comprised of one or more electromagnets 925. Illustrative and non-restrictive examples of electromagnets 925 include iron core electromagnets, ferrite core electromagnets and superconducting magnets. According to some embodiments, the superconducting magnets may comprise niobium-titanium and/or niobium-tin.

According to some embodiments, the magnetic field resulting from energizing the current carrying element 910 may be strongest in the region close to an inner surface of the system component 915. As such, the magnetic field may provide a strong repulsive force against mobile charged ions as indicated by the ion paths 905 for the direction of fluid flow 920, resulting in a drift towards the center and an ion concentration gradient across the system component 915 diameter, with the lowest concentration near the inner surface of the system component. According to some embodiments, the magnetic field resulting from energizing the current carrying element 910 may operate to counteract radial motion of solute ions, with the effect strongest at the inner surface of the system component 915, in a mode of operation similar to synchrotron quadru- and multi-pole focusing arrays.

Embodiments provide that the number and/or certain properties of electromagnets 925 and the number of rings within the current carrying element 910 may be adjusted to provide various magnetic field characteristics. For example, such magnetic field characteristics may include a more even and/or larger magnetic field within the system component 915. For instance, the shape of the electromagnets 925 may be selected to extend longitudinally along the length of the system component 915 to eliminate the need for multiple stages. In another instance, the strength of each electromagnet 925, as determined by the current, may be adjusted to provide an appropriate depth of penetration into the fluid, such as when balancing wall protection of the inner surface with power demand

The current carrying element 930 depicted in FIG. 9B comprises a larger number of smaller electromagnets 935. According to some embodiments, the structure of the current carrying element 930 may operate to provide a more even magnetic field within the system component 915.

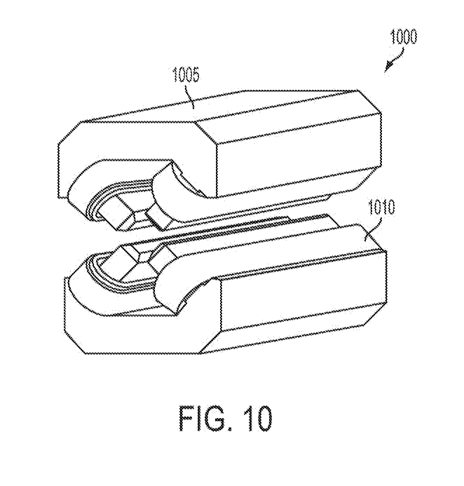

FIG. 10 depicts an illustrative current carrying element comprising electromagnets according to a third embodiment. As shown in FIG. 10, a current carrying element 1000 may include longitudinally elongated quadrapoles. Each quadrapole may include coils 1010 wound around a magnetic core material 1005. A system component (not shown) may be arranged within the center bore of the current carrying element 1000. According to some embodiments, the superposition of the magnetic fields resulting from each electromagnet of the current carrying element 1000 may produce an overall internal magnetic field within a system component that causes ions to migrate to the center of the system component, thereby reducing the number of corrosive ions that contact the inner surface thereof.

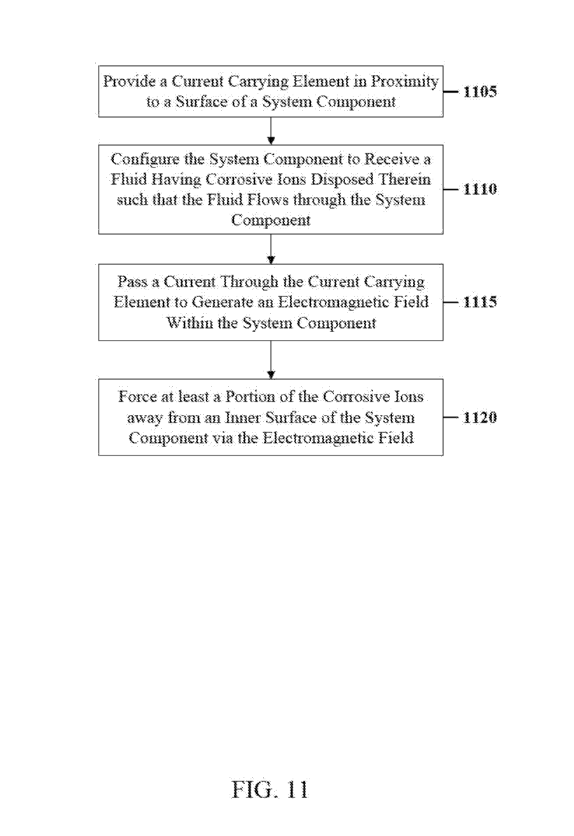

FIG. 11 depicts a flow diagram for an illustrative method of reducing corrosion in a supercritical water gasification system. A current carrying element may be provided 1105 in proximity to a surface of a system component. For example, a continuous solenoid comprising copper wire may be arranged around the outside surface of a heater. The system component may be configured 1110 to receive a fluid having corrosive ions disposed therein such that the fluid flows through the system component. For instance, the heater may comprise an inlet configured to receive a slurry being pumped through the supercritical water gasification system by one or more pumps. The heater may be configured to heat the slurry, for example, before the slurry is fed into a reactor vessel. The slurry may have corrosive ions, such as chloride ions, fluoride ions, and/or sulfide ions.

A current may be passed 1115 through the current carrying element to generate an electromagnetic field within the system component. For example, a power source may provide a direct current to the current carrying element configured as a solenoid. The direct current traveling through the solenoid may operate to generate an electromagnetic field within the system component. The electromagnetic field may force 1120 at least a portion of the corrosive ions away from an inner surface of the system component. For instance, the electromagnetic field may provide for Lorentz forces that move ions flowing through the system component away from an inner surface of the system component and toward a center region of the system component. In this manner, the corrosive ions contacting the inner surface are reduced or eliminated, decreasing a cause of corrosion of the inner surface.

### EXAMPLES

### Example 1

### Continuous Solenoid Current Carrying Element

A supercritical water coal gasification system will be configured to generate a synthesis gas including at least about 50% by volume of H₂ from a coal-water slurry. The coal-water slurry will be heated to a supercritical temperature of about 900 Kelvin within a preheater vessel fabricated from a nickel alloy material. The coal-water slurry will flow through the preheater vessel, entering into a low corrosion zone at about 450 Kelvin, moving through a high corrosion zone where it will be heated to about 570 Kelvin before being heated to the supercritical temperature within the supercritical zone. The pressure within the preheater vessel will be maintained at about 25 megapascals. The coal-water slurry will include ions corrosive to the nickel alloy inner surface of the preheater vessel, with the highest concentration being within the high corrosion zone. The corrosive ions will include chloride ions, fluoride ions, carbonate ions, bicarbonate ions, hydroxide ions, sulfate ions, and oxide ions.

A current carrying element will be arranged around the outer surface of the high corrosion zone. The current carrying element will include a continuous solenoid of tightly wound copper wires. A power supply will energize the current carrying element by providing direct current running in the same direction as the flow of the coal-water slurry through the preheater vessel.

During the supercritical water coal gasification process, the coal-water slurry will flow through the preheater vessel. The energized current carrying element will generate a magnetic field of about 2 teslas within the preheater vessel. The magnetic field will force magnetically susceptible particles to flow in paths away from the inner surface and toward a substantially center region of the preheater vessel. The magnetically susceptible particles include corrosive ions, including cations and anions, such as chloride ions, fluoride ions, carbonate ions, bicarbonate ions, hydroxide ions, and oxide ions. The number of corrosive ions contacting the inner surface will be substantially eliminated, prolonging the lifespan of the reactor vessel.

### Example 2

### Current Carrying Rods Element

A supercritical water coal gasification system will be configured to generate a synthesis gas including H₂ and CH₄ from a coal-water slurry. The coal-water slurry will be heated to a supercritical temperature of about 850 Kelvin within a reactor vessel fabricated from a chrome-molybdenum material. The coal-water slurry will flow through the reactor vessel, entering into a low corrosion zone at about 450 Kelvin, moving through a high corrosion zone where it will be heated to about 570 Kelvin before being heated to the supercritical temperature within the supercritical zone. The pressure within the reactor vessel will be maintained at about 25 megapascals. The coal-water slurry will include ions corrosive to the chrome-molybdenum alloy inner surface of the reactor vessel, with the highest concentration being within the high corrosion zone. The corrosive ions will include anions and cations.

A current carrying element will be arranged around the outer surface of the high corrosion zone. The current carrying element will include current carrying rods embedded in a surface of the reactor vessel. The current carrying element will be connected to a first power supply that will energize the current carrying element by providing direct current running in the same direction as the flow of the coal-water slurry through the reactor vessel.

During the supercritical water coal gasification process, the coal-water slurry will flow through the reactor vessel. Responsive to the first power supply being energized, the current carrying element which will generate a magnetic field of about 1.5 teslas within the reactor vessel. The magnetic field will force dissolved anions in the coal slurry to flow in paths away from the inner surface and toward a substantially center region of the reactor vessel. Responsive to the second power supply being energized, the current carrying element which will generate a magnetic field of about 1.5 teslas within the reactor vessel. The magnetic field will force dissolved cations in the coal slurry to flow in paths away from the inner surface and toward a substantially center region of the reactor vessel. The number of corrosive ions, including cations and anions, contacting the inner surface will be substantially eliminated, prolonging the lifespan of the reactor vessel.

### Example 3

### Tapered Solenoid Current Carrying Element

A waste oxidization gasification system will be configured to generate a synthesis gas including H₂ from a waste slurry. The waste slurry will enter a heater within a subcritical zone at about 510 Kelvin and will be heated to about 600 Kelvin before flowing into a reactor vessel in fluid communication with the heater. At 510 Kelvin, corrosive ions will be dissolved in the waste slurry that are corrosive to the inner surface of the heater.

A current carrying element will be arranged around the outer surface of the subcritical zone. The current carrying element will include a tapered solenoid of tightly wound copper wires. A power supply will energize the current carrying element by providing direct current running in the same direction as the flow of the coal-water slurry through the reactor vessel. The energized current carrying element will generate a magnetic field of about 1.75 teslas. The magnetic field will cause an ion drift which will force the dissolved ions towards the center of the heater, which maintains a central location of the dissolved ions and causes central migration of newly dissolved ions. The corrosive effects of the waste slurry in the heater will be reduced, diminishing corrosion of the heater.

### Example 4

### Electromagnet Current Carrying Element

A supercritical water gasification system will be configured to generate a synthesis gas including H₂, CO₂, CH₄, and CO from a biomass-water feedstock. The biomass-water feedstock will be in the form of a liquid biomass slurry that will react with supercritical water in a reactor vessel of the supercritical water gasification system to generate the synthesis gas. The biomass-water slurry will be introduced into the system and will be heated in a heater before entering the reactor vessel. The heater will be manufactured from a non-magnetic iron-based alloy and will have a height of about 2.5 meters and a circumference of about 1.5 meters. The heater will heat the water-biomass slurry to a subcritical temperature of about 620 Kelvin at a pressure of about 22.1 megapascals before feeding the water-biomass fluid to the reactor vessel. At this subcritical temperature, the water-biomass slurry will include corrosive ions, such as sulfide ions, sulfate ions, sulfite ions, phosphate ions, nitrate ions, and cyanide ions.

A current carrying element including 16 electromagnets arranged in rings of 4 evenly spaced electromagnets will be arranged around the outer surface of the heater. The electromagnets will include iron core electromagnets. The electromagnets will be energized during the supercritical water gasification process to create a electromagnetic field of about 2.5 teslas within the heater. The electromagnetic field will penetrate about 0.25 meters within the inside of the heater. The paths of the sulfide ions, sulfate ions, sulfite ions, phosphate ions, nitrate ions, and cyanide ions flowing through the heater will be forced away from the inner surface and toward the center of the heater such that the number of such ions contacting the inner surface is greatly reduced.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to”). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example), the bare recitation of “two recitations,” without other modifiers, means at least two recitations, or two or more recitations). Furthermore, in those instances where a convention analogous to “at least one of A, B, and C, or the like” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, or the like). In those instances where a convention analogous to “at least one of A, B, C, or the like” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, or the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, and the like. As a non-limiting example, each range discussed herein can be readily broken down into a lower third, middle third and upper third, and the like. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A reactor system configured to reduce corrosion thereof, the system comprising:
at least one current carrying element arranged in proximity to a surface of at least a portion of the reactor system;
at least one pump configured to force fluid having corrosive ions disposed therein through the at least a portion of the reactor system; and
a current generator configured to pass a current through the at least one current carrying element to generate an electromagnetic field within the reactor system, wherein the electromagnetic field operates to reduce corrosion by forcing at least a portion of the corrosive ions away from an inner surface of the reactor system.

2. The system of claim 1, wherein the reactor system is configured as a supercritical water reactor system.

3. The system of claim 1, wherein the reactor system is configured as one of the following: a coal gasification system, a biomass gasification system, a waste oxidation system, a hydroprocessing reactor, and a pressurized water reactor.

4. The system of claim 1, wherein the fluid comprises one of the following: a coal slurry and a wet biomass.

5. The system of claim 1, wherein the at least one current carrying element comprises a wire.

6. The system of claim 5, wherein the wire comprises an insulated high current carrying wire.

7. The system of claim 5, wherein the wire comprises a Litz wire.

8. The system of claim 1, wherein the at least one current carrying element comprises a plurality of current carrying rods.

9. The system of claim 8, wherein the plurality of current carrying rods are arranged longitudinally around the at least a portion of the reactor system.

10. The system of claim 9, wherein each of the plurality of current carrying rods carries current in the same direction.

11. The system of claim 1, wherein the at least one current carrying element comprises at least one coil.

12. The system of claim 11, wherein the at least a portion of the reactor system is tapered.

13. The system of claim 11, wherein the at least one coil is configured as a continuous solenoid.

14. The system of claim 13, wherein the continuous solenoid is tapered.

15. The system of claim 1, wherein the at least one current carrying element comprises at least one ring arranged around the at least a portion of the reactor system.

16. The system of claim 1, wherein the at least one current carrying element comprises a plurality of rings of varying diameters arranged in order from a largest diameter to a smallest diameter.

17. The system of claim 1, wherein the at least a portion of the reactor system comprises at least a portion of one of the following: a reactor vessel, a pre-heater, a valve, a conduit, and a heat exchanger.

18. The system of claim 1, wherein the at least one current carrying element is arranged around at least a portion of a pre-heater.

19. The system of claim 1, wherein the at least one current carrying element is arranged around at least a portion of a heat exchanger.

20. The system of claim 1, wherein the at least one current carrying element is arranged around at least a portion of a reactor vessel.

21. The system of claim 1, wherein the at least one current carrying element is arranged around at least a portion of a supercritical zone of a reactor vessel.

22. The system of claim 1, wherein the at least one current carrying element is arranged around at least a portion of a sub-critical zone of a reactor vessel.

23. The system of claim 1, wherein the at least one current carrying element comprises a plurality of electromagnets.

24. The system of claim 23, wherein the plurality of electromagnets is arranged in at least one ring around the at least a portion of the reactor system.

25. The system of claim 23, wherein each of the plurality of electromagnets comprises at least one of the following: an iron core and a ferrite core.

26. The system of claim 23, wherein each of the plurality of electromagnets comprise a superconducting magnet.

27. The system of claim 26, where the superconducting magnet comprises at least one of the following: niobium-titanium and niobium-tin.

28. The system of claim 1, wherein the electromagnetic field is configured to force at least a portion of the corrosive ions away from the inner surface through Lorentz forces.

29. The system of claim 1, wherein the electromagnetic field is configured to force at least a portion of the corrosive ions away from the inner surface and into a centralized region of the at least a portion of the reactor system.

30. The system of claim 1, wherein the at least a portion of the corrosive ions comprises anions.

31. The system of claim 30, wherein the anions comprise at least one of the following: chloride ions, fluoride ions, sulfide ions, sulfate ions, sulfite ions, phosphate ions, nitrate ions, carbonate ions, bicarbonate ions, hydroxide ions, oxide ions, and cyanide ions.

32. The system of claim 1, wherein the at least a portion of the corrosive ions comprises anions and cations.

33. The system of claim 1, wherein the current comprises direct current.

34. The system of claim 33, wherein the electromagnetic field comprises a static magnetic field.

35. The system of claim 1, wherein the current comprises alternating current.

36. The system of claim 35, wherein the alternating current is about 100 kilohertz to about 500 kilohertz.

37. The system of claim 1, wherein the electromagnetic field is about 0.5 teslas to about 4 teslas.

38. The system of claim 1, wherein the electromagnetic field is about 2 teslas.

39. The system of claim 1, wherein the surface comprises a non-magnetizable material.

40. The system of claim 1, wherein the surface comprises at least one of the following: a nickel alloy, a chrome-molybdenum alloy, a non-magnetic iron-based alloy, and a ceramic.

41. A corrosion reduction method for a reactor system, the method comprising:
providing a reactor system having at least one current carrying element in proximity to a surface of at least a portion of the reactor system;
moving fluid having corrosive ions disposed therein through the at least a portion of the reactor system; and
passing a current through the at least one current carrying element to generate an electromagnetic field within the at least a portion of the reactor system, whereby the electromagnetic field forces at least a portion of the corrosive ions away from an inner surface of the reactor system.

42. The method of claim 41, further comprising configuring the reactor system as a supercritical water reactor system.

43. The method of claim 41, further comprising configuring the reactor system as one of the following: a coal gasification system, a biomass gasification system, a waste oxidation system, a hydroprocessing reactor, and a pressurized water reactor.

44. The method of claim 41, wherein the fluid comprises a coal slurry of a coal gasification process.

45. The method of claim 41, wherein the fluid comprises a wet biomass of a biomass gasification process.

46. The method of claim 41, wherein the at least one current carrying element comprises a wire.

47. The method of claim 46, wherein the wire comprises an insulated high current carrying wire.

48. The method of claim 46, wherein the wire comprises a Litz wire.

49. The method of claim 41, wherein the at least one current carrying element comprises a plurality of current carrying rods.

50. The method of claim 49, wherein the plurality of current carrying rods are arranged longitudinally around the at least a portion of the reactor system.

51. The method of claim 50, wherein each of the plurality of current carrying rods carries current in the same direction.

52. The method of claim 41, wherein the at least one current carrying element comprises at least one coil.

53. The method of claim 52, wherein the at least a portion of the reactor system is tapered.

54. The method of claim 52, wherein the at least one coil is configured as a continuous solenoid.

55. The method of claim 54, wherein the continuous solenoid is tapered.

56. The method of claim 41, wherein the at least one current carrying element comprises at least one ring arranged around the at least a portion of the reactor system.

57. The method of claim 41, wherein the at least one current carrying element comprises a plurality of rings of varying diameters arranged in order from a largest diameter to a smallest diameter.

58. The method of claim 41, wherein the at least a portion of the reactor system comprises at least a portion of one of the following: a reactor vessel, a pre-heater, a valve, a conduit, and a heat exchanger.

59. The method of claim 41, wherein the at least one current carrying element is arranged around at least a portion of a pre-heater.

60. The method of claim 41, wherein the at least one current carrying element is arranged around at least a portion of a heat exchanger.

61. The method of claim 41, wherein the at least one current carrying element is arranged around at least a portion of a reactor vessel.

62. The method of claim 41, wherein the at least one current carrying element is arranged around at least a portion of a supercritical zone of the reactor vessel.

63. The method of claim 41, wherein the at least one current carrying element is arranged around at least a portion of a sub-critical zone of a reactor vessel.

64. The method of claim 41, wherein the at least one current carrying element comprises a plurality of electromagnets.

65. The method of claim 64, wherein each of the plurality of electromagnets comprises at least one of the following: an iron core and a ferrite core.

66. The method of claim 64, wherein the plurality of electromagnets are arranged in at least one ring around the at least a portion of the reactor system.

67. The method of claim 64, wherein each of the plurality of electromagnets comprise a superconducting magnet.

68. The method of claim 67, where the superconducting magnet comprises at least one of the following: niobium-titanium and niobium-tin.

69. The method of claim 41, wherein the electromagnetic field operates to force at least a portion of the corrosive ions away from the inner surface through Lorentz forces.

70. The method of claim 41, wherein the electromagnetic field operates to force at least a portion of the corrosive ions away from the inner surface and into a centralized region of the at least a portion of the reactor system.

71. The method of claim 41, wherein the at least a portion of the corrosive ions comprises anions.

72. The method of claim 71, wherein the anions comprise at least one of the following: chloride ions, fluoride ions, sulfide ions, sulfate ions, sulfite ions, phosphate ions, nitrate ions, carbonate ions, bicarbonate ions, hydroxide ions, oxide ions, and cyanide ions.

73. The method of claim 41, wherein the at least a portion of the corrosive ions comprises anions and cations.

74. The method of claim 41, wherein the current comprises direct current.

75. The method of claim 74, wherein the electromagnetic field comprises a static magnetic field.

76. The method of claim 41, wherein the current comprises alternating current.

77. The method of claim 76, wherein the alternating current is about 100 kilohertz to about 500 kilohertz.

78. The method of claim 77, wherein the electromagnetic field is about 0.5 teslas to about 4 teslas.

79. The method of claim 41, wherein the surface comprises a non-magnetizable material.

80. The method of claim 41, wherein the surface comprises at least one of the following: a nickel alloy, a chrome-molybdenum alloy, a non-magnetic iron-based alloy, and a ceramic.

81. The method of claim 41, wherein a rate of corrosion of the inner surface due to the fluid is lower when the current is being passed through the at least one current carrying element, and the rate of corrosion is higher when the current is not being passed through the at least one current carrying element.

82. A method of manufacturing a reactor system configured to reduce corrosion thereof, the method comprising:
providing a reactor system having at least one current carrying element in proximity to a surface of at least a portion of the reactor system;
configuring at least one pump to force fluid having corrosive ions disposed therein through the at least a portion of the reactor system; and
connecting the at least one current carrying element to a current generator configured to pass a current through the at least one current carrying element such that an electromagnetic field is generated within the reactor system that operates to reduce corrosion by forcing at least a portion of the corrosive ions away from an inner surface of the reactor system.

83. The method of claim 82, further comprising configuring the reactor system as a supercritical water reactor system.

84. The method of claim 82, further comprising configuring the reactor system as one of the following: a coal gasification system, a biomass gasification system, a waste oxidation system, a hydroprocessing reactor, and a pressurized water reactor.

85. The method of claim 82, wherein the at least one current carrying element comprises a wire.

86. The method of claim 82, wherein the at least one current carrying element comprises a plurality of current carrying rods.

87. The method of claim 86, wherein the plurality of current carrying rods are arranged longitudinally around the at least a portion of the reactor system.

88. The method of claim 87, wherein each of the plurality of current carrying rods carries current in the same direction.

89. The method of claim 82, wherein the at least one current carrying element comprises at least one coil.

90. The method of claim 82, further comprising tapering the at least a portion of the reactor system.

91. The method of claim 82, wherein the at least a portion of the reactor system comprises at least a portion of at least one of the following: a reactor vessel, a pre-heater, a valve, a conduit, and a heat exchanger.

92. The method of claim 82, wherein the at least one current carrying element is arranged around at least a portion of a pre-heater.

93. The method of claim 82, wherein the at least one current carrying element is arranged around at least a portion of a heat exchanger.

94. The method of claim 82, wherein the at least one current carrying element is arranged around at least a portion of a reactor vessel.

95. The method of claim 82, wherein the at least one current carrying element is arranged around at least a portion of a supercritical zone of a reactor vessel.

96. The method of claim 82, wherein the at least one current carrying element is arranged around at least a portion of a sub-critical zone of a reactor vessel.

97. The method of claim 82, wherein the at least one current carrying element comprises a plurality of electromagnets.

98. The method of claim 97, wherein the plurality of electromagnets are arranged in at least one ring around the at least a portion of the reactor system.

99. The method of claim 82, wherein the current generator is configured to provide direct current.

100. The method of claim 82, wherein the current generator is configured to provide alternating current.

101. The method of claim 82, wherein the surface comprises a non-magnetizable material.

102. The method of claim 82, wherein the surface comprises a nickel alloy.

103. A method of reducing corrosion in a coal gasification supercritical water reactor system, the method comprising:
arranging at least one current carrying element around at least a portion of a sub-critical zone of a reactor vessel of the supercritical water reactor system;
moving coal slurry having corrosive ions disposed therein through the reactor vessel from the sub-critical zone to a supercritical zone;
passing a current through the at least one current carrying element to generate an electromagnetic field within the reactor vessel; and
forcing, via the electromagnetic field, at least a portion of the corrosive ions away from an inner surface of the reactor vessel.

104. The method of claim 103, wherein the at least one current carrying element is embedded within a wall of the reactor vessel.

105. The method of claim 103, further comprising configuring the reactor vessel to retain heat generated by interactions between the corrosive ions and the electromagnetic field to heat the coal slurry.

106. The method of claim 105, wherein movement of the coal slurry through the at least a portion of the supercritical water reactor vessel operates to cool the at least one current carrying element.

107. The method of claim 103, further comprising arranging at least one current carrying element around a pre-heater component of the supercritical water reactor system.

108. The method of claim 103, further comprising arranging at least one current carrying element around a heat exchanger component of the supercritical water reactor system.

109. The method of claim 103, wherein a rate of corrosion of the inner surface due to the coal slurry is lower when the current is being passed through the at least one current carrying element and the rate of corrosion is higher when the current is not being passed through the at least one current carrying element.
